(19) United States
(12) Patent Application Publication
(10) Pub. No.: US 2026/0183584 A1
(43) Pub. Date: Jul. 2, 2026

(54) FIRE EXTINGUISHING MATERIAL, FIRE EXTINGUISHING MATERIAL ROLL, AND METHOD OF PRODUCING FIRE EXTINGUISHING MATERIAL

(71) Applicant: TOPPAN Holdings Inc., Tokyo (JP)

(72) Inventors: Shunta KAKEGAWA, Tokyo (JP); Tomomichi OOBUCHI, Tokyo (JP); Kenjiro KURODA, Tokyo (JP); Yasuharu SHIINE, Tokyo (JP); Masato KUROKAWA, Tokyo (JP); Yusaku HONJO, Tokyo (JP); Manami ISOWA, Tokyo (JP)

(73) Assignee: TOPPAN Holdings Inc., Tokyo (JP)

(21) Appl. No.: 19/546,475

(22) Filed: Feb. 23, 2026

Related U.S. Application Data
(63) Continuation of application No. PCT/JP2024/030016, filed on Aug. 23, 2024.

(30) Foreign Application Priority Data
Sep. 1, 2023 (JP) 2023-142402

(51) Int. Cl. A62C 8/00; A62C 8/06

(52) U.S. Cl. CPC A62C 8/005; A62C 8/06

(57) ABSTRACT

A fire extinguishing material includes multiple parts of a fire extinguishing agent layer containing a fire extinguishing agent and arranged at intervals from each other, and a packaging material individually encapsulating the multiple parts of the fire extinguishing agent layer. A fire extinguishing material roll is formed by winding the fire extinguishing material in a roll. A method of producing a fire extinguishing material includes a fire extinguishing agent layer forming step in which multiple parts of a fire extinguishing agent layer containing a fire extinguishing agent are formed, and an encapsulating step in which the multiple parts of the fire extinguishing agent layer are individually encapsulated in a packaging material at intervals from each other.

### CROSS-REFERENCE TO RELATED APPLICATIONS

The present application is a bypass continuation of International Application No. PCT/JP2024/030016, filed Aug. 23, 2024, which claims priority to Japanese Patent Application No. 2023-142402, filed Sep. 1, 2023, the entire contents of each are incorporated herein by reference in their entirety.

### TECHNICAL FIELD

The present disclosure relates to fire extinguishing materials, fire extinguishing material rolls, and methods of producing fire extinguishing material

### BACKGROUND ART

In order to minimize damage caused by fire, it is desirable that some kind of fire extinguishing work (initial fire extinguishing) be performed shortly after ignition. By placing fire extinguishing materials containing fire extinguishing agents such as organic salts and inorganic salts near objects that may ignite, it is expected that fire extinction be completed before a person perceives ignition of the objects. From this perspective, fire extinguishing materials have been proposed in which a fire extinguishing agent is sealed in a packaging bag (e.g., see PTL 1). If a fire breaks out in a place where this type of fire extinguishing material is used, the fire extinguishing agent reacts with the fire, dissolving the packaging bag on the side facing the fire to create a large hole, from which the reacted fire extinguishing agent is released forcefully toward the fire to extinguish the fire.

### CITATION LIST

### Patent Literature

PTL 1: WO2023/277040

### SUMMARY OF THE INVENTION

### Technical Problem

Depending on the type of fire, there is a possibility that ignition may occur at multiple points and chain reaction may occur over a wide area, resulting in a multi-stage fire. In particular, in the case of a fire inside a distribution panel, a multi-stage fire can easily occur because the arising flames may track along the wiring. However, in the case of the conventional fire extinguishing material mentioned above, all or most of the material is consumed in one reaction, and therefore it will be difficult to react at the second or subsequent times. This means that multi-stage fires cannot be necessarily dealt with.

One possible measure against this may be installing a large-area fire extinguishing material so that, even if a portion of the fire extinguishing agent may react, there will remain an area of unreacted fire extinguishing agent. However, with the conventional fire extinguishing material described above, a hole is created in the packaging bag by the first fire extinguishing reaction, and when the material reacts at the second or subsequent times, the hole already created in the packaging bag may cause the fire extinguishing agent to lose its directionality and significantly reduce the fire extinguishing performance.

The present disclosure has been made to solve such issues and aims to provide a fire extinguishing material, a fire extinguishing material roll, and a method of producing a fire extinguishing material, which can handle multi-stage fires.

### Solution to Problems

[1] A fire extinguishing material according to the present disclosure includes multiple parts of a fire extinguishing agent layer containing a fire extinguishing agent and arranged at intervals from each other, and a packaging material individually encapsulating the multiple parts of the fire extinguishing agent layer.

In the fire extinguishing material, the multiple parts of the fire extinguishing agent layer arranged at intervals from each other are individually encapsulated in a packaging material, and therefore chain reaction of the fire extinguishing agent can be suppressed between the multiple parts of the fire extinguishing agent layer. In other words, even if one part of the fire extinguishing agent layer may react and be consumed, other parts of the fire extinguishing agent layer can remain unreacted. Furthermore, even if a portion of the packaging material encapsulating one part of the fire extinguishing agent layer may be melted creating a hole, other parts of the fire extinguishing agent layer can remain encapsulated in the packaging material. Thus, the multiple parts of the fire extinguishing agent layer can react in a multi-stage manner, enabling handling of a multi-stage fire. In other words, fire can be extinguished in a multi-stage manner.

[2] In the fire extinguishing material according to [1], the fire extinguishing agent may contain at least either of an organic salt and an inorganic salt. In the fire extinguishing material, due to the fire extinguishing agent containing at least either of an organic salt and an inorganic salt, appropriate fire extinguishing performance can be achieved.

[3] In the fire extinguishing material according to [2], the fire extinguishing agent may contain a compound having an oxidizing effect. In the fire extinguishing material, due to the fire extinguishing agent containing an oxidizing compound, aerosols can be generated by receiving thermal energy from a fire.

[4] In fire extinguishing material according to any of [1] to [3], the fire extinguishing agent may contain potassium citrate and potassium chlorate. In the fire extinguishing material, due to the fire extinguishing agent containing potassium citrate and potassium chlorate, appropriate fire extinguishing performance can be achieved.

[5] In the fire extinguishing material according to any of [1] to [4], the multiple parts of the fire extinguishing agent layer may contain a binder. In the fire extinguishing material, due to the multiple parts of the fire extinguishing agent layer containing a binder, properties of the fire extinguishing agent can be easily maintained, and the frequency of replacing the fire extinguishing material can be reduced.

[6] In the fire extinguishing material according to any of [1] to [5], a content of the fire extinguishing agent in the fire extinguishing agent layer may be 70 mass % or more and 97 mass % or less. In the fire extinguishing material, due to the content of the fire extinguishing agent in the fire extinguishing agent layer being 70 mass % or more, excellent fire extinguishing performance can be easily achieved. Also, due to the content of the fire extinguishing agent in the fire extinguishing agent layer being 97 mass % or less, deliquescence of the fire extinguishing agent can be easily suppressed, and a uniform fire extinguishing agent layer can be easily formed.

[7] In the fire extinguishing material according to any of [1] to [6], the packaging material may be formed into a long shape, and the multiple parts of the fire extinguishing agent layer may be arranged in a length direction of the packaging material. In the fire extinguishing material, due to the multiple parts of the fire extinguishing agent layer being arranged in the length direction, a multi-stage fire in the length direction of the packaging material can be handled. Also, since the fire extinguishing material can be used cut and divided in the length direction, the fire extinguishing material can be formed into various shapes, enhancing installation flexibility.

[8] In the fire extinguishing material according to [7], the multiple parts of the fire extinguishing agent layer may also be arranged in a width direction of the packaging material, the width direction being perpendicular to the length direction. In the fire extinguishing material, due to the parts of the fire extinguishing agent layer being also arranged in the width direction, a multi-stage fire in the width direction of the packaging material can be handled. Also, since the fire extinguishing material can be used cut and divided in the width direction, the fire extinguishing material can be formed into various shapes, enhancing installation flexibility.

[9] In the fire extinguishing material according to any of [1] to [8], a shortest distance between adjacent parts of the fire extinguishing agent layer may be 10 mm or more. In the fire extinguishing material, due to the shortest distance between adjacent parts of the fire extinguishing agent layer being 10 mm or more, mutual reaction can be suppressed between adjacent parts of the fire extinguishing agent layer. Also, if the fire extinguishing material is cut between adjacent parts of the fire extinguishing agent layer, ingress of the moisture that has permeated through the cut surface to the fire extinguishing agent layer can be retarded. In particular, by cutting the fire extinguishing material at the center between adjacent parts of the fire extinguishing agent layer, the distance from the cut surface to the fire extinguishing agent layer can be 5 mm or more, and therefore ingress of the moisture that has permeated through the cut surface to the fire extinguishing agent layer can be further retarded. Therefore, even if a fire extinguishing agent having deliquescence is used, performance deterioration of the fire extinguishing agent layer can be suppressed over a long period of time.

In the fire extinguishing material according to any of [1] to [9], a shortest distance from the multiple parts of the fire extinguishing agent layer to an edge of the packaging material may be 5 mm or more. In the fire extinguishing material, due to the shortest distance from the multiple parts of the fire extinguishing agent layer to the edge of the packaging material being 5 mm or more, moisture that has penetrated from the edge of the packaging material is less likely to reach the fire extinguishing agent layer. Therefore, even if a fire extinguishing agent having deliquescence is used, performance deterioration of the fire extinguishing agent layer can be suppressed over a long period of time.

In the fire extinguishing material according to any of [1] to [10], the packaging material may have perforations formed between adjacent parts of the fire extinguishing agent layer. In the fire extinguishing material, due to the packaging material having perforations formed between adjacent parts of the fire extinguishing agent layer, the fire extinguishing material can be easily cut between adjacent parts of the fire extinguishing agent layer.

[12] In the fire extinguishing material according to [11], a shortest distance from a part of the fire extinguishing agent layer closest to a perforation to the perforation may be 5 mm or more. In the fire extinguishing material, due to the shortest distance from a part of the fire extinguishing agent layer closest to a perforation to the perforation being 5 mm or more, if the fire extinguishing material is cut along the perforation, ingress of the moisture that has permeated through the cut surface to the fire extinguishing agent layer can be retarded. Therefore, even if a fire extinguishing agent having deliquescence is used, performance deterioration of the fire extinguishing agent layer can be suppressed over a long period of time.

The fire extinguishing material according to any of [1] to [12] may further include multiple parts of a substrate laminated on the respective multiple parts of the fire extinguishing agent layer. In the fire extinguishing material, due to the multiple parts of the fire extinguishing agent layer being laminated with the respective multiple parts of the substrate, handleability of the multiple parts of the fire extinguishing agent layer is improved when encapsulating them individually in the packaging material.

The fire extinguishing material according to any of [1] to [12] may further include a substrate laminated on the multiple parts of the fire extinguishing agent layer. In the fire extinguishing material, due to the substrate being laminated with the multiple parts of the fire extinguishing agent layer, handleability of the multiple parts of the fire extinguishing agent layer is improved when encapsulating them individually in the packaging material. Also, misalignment in positional relationship between the multiple parts of the fire extinguishing agent layer can be suppressed when encapsulating them individually in the packaging material.

In the fire extinguishing material according to any of [1] to [14], the packaging material may include a first film and a second film welded to the first film so as to sandwich the multiple parts of the fire extinguishing agent layer. In the fire extinguishing material, due to the packaging material including the first film and the second film welded to the first film so as to sandwich the multiple parts of the fire extinguishing agent layer therebetween, the fire extinguishing material can be easily produced.

In the fire extinguishing material according to [15], the first film and the second film may have a water vapor permeability of 10 g/m²/day or less. In the fire extinguishing material, due to the first and second films having a water vapor permeability of 10 g/m²/day or less, even if a fire extinguishing agent having deliquescence is used, performance deterioration of the fire extinguishing agent layer can be suppressed over a long period of time.

[17] A fire extinguishing material roll according to the present disclosure is formed by winding the fire extinguishing material according to any of [1] to [16] in a roll. In the fire extinguishing material roll, due to the roll being formed by winding the fire extinguishing material in a roll, storage and handleability of the fire extinguishing material are improved.

[18] A method of producing a fire extinguishing material according to the present disclosure includes a fire extinguishing agent layer forming step in which multiple parts of the fire extinguishing agent layer containing a fire extinguishing agent are formed; and an encapsulating step in which the multiple parts of the fire extinguishing agent layer are individually encapsulated in a packaging material at intervals from each other. In the method of producing a fire extinguishing material, multiple parts of the fire extinguishing agent layer containing a fire extinguishing agent are formed, and the multiple parts of the fire extinguishing agent layer are individually encapsulated in a packaging material at intervals from each other, and therefore a fire extinguishing material capable of handling a multi-stage fire can be produced.

In the method of producing a fire extinguishing material according to [18], in the fire extinguishing agent layer forming step, a fire extinguishing agent layer-forming composition for forming the fire extinguishing agent layer may be applied to a substrate, and the substrate and the fire extinguishing agent layer-forming composition may be cut together. In the method of producing a fire extinguishing material, multiple parts of the fire extinguishing agent layer can be easily formed by applying the fire extinguishing agent layer-forming composition to the substrate, and cutting the fire extinguishing agent layer-forming composition and the substrate together.

In the method of producing a fire extinguishing material according to [19], the packaging material may include a first film and a second film, and in the encapsulating step, the first film and the second film may be welded together so as to sandwich the multiple parts of the fire extinguishing agent layer therebetween. In the method of producing a fire extinguishing material, multiple parts of the fire extinguishing agent layer can be individually encapsulated with ease by welding the first and second films together so as to sandwich the multiple parts of the fire extinguishing agent layer therebetween.

In the method of producing a fire extinguishing material according to [18], in the fire extinguishing agent layer forming step, a fire extinguishing agent layer-forming composition for forming the fire extinguishing agent layer may be intermittently applied to a substrate, and in the encapsulating step, the substrate to which the fire extinguishing agent layer-forming composition has been intermittently applied may be encapsulated in the packaging bag. In the method of producing a fire extinguishing material, multiple parts of the fire extinguishing agent layer can be formed by intermittently applying the fire extinguishing agent layer-forming composition to the substrate. Then, by encapsulating the substrate, to which the fire extinguishing agent layer-forming composition has been intermittently applied, in the packaging material, the multiple parts of the fire extinguishing agent layer can be individually encapsulated with ease.

In the method of producing a fire extinguishing material according to [21], the packaging material may include a first film and a second film, and in the encapsulating step, the first film and the second film may be welded together so as to sandwich therebetween the substrate to which the fire extinguishing agent layer-forming composition has been intermittently applied. In the method of producing a fire extinguishing material, multiple parts of the fire extinguishing agent layer can be individually encapsulated with ease by welding the first and second films together so as to sandwich therebetween the substrate to which the fire extinguishing agent layer-forming composition has been intermittently applied.

The method of producing a fire extinguishing material according to any of [18] to [22] may further include a winding step in which the fire extinguishing material is wound up in a roll. In the method of producing a fire extinguishing material, the fire extinguishing material roll can be produced by winding the fire extinguishing material in a roll.

### Advantageous Effects of the Invention

According to the present disclosure, multi-stage fires can be handled.

### BRIEF DESCRIPTION OF THE DRAWINGS

FIG. 1 is a schematic perspective view illustrating a fire extinguishing material roll according to a first embodiment.

FIG. 2 is a schematic plan view illustrating a fire extinguishing material according to the first embodiment.

FIG. 3 is a schematic cross-sectional view taken along the line III-III of FIG. 2.

FIGS. 4(a), 4(b) and 4(c) are schematic cross-sectional views illustrating a fire extinguishing agent layer forming step.

FIG. 5 is a schematic cross-sectional view illustrating an encapsulating step.

FIG. 6 is a schematic cross-sectional view illustrating a fire extinguishing material according to a second embodiment.

FIG. 7 is a schematic cross-sectional view illustrating a fire extinguishing agent layer forming step.

FIG. 8 is a schematic cross-sectional view illustrating an encapsulating step.

FIG. 9 is a schematic cross-sectional view illustrating a fire extinguishing material according to a third embodiment.

FIG. 10 is a schematic cross-sectional view illustrating a fire extinguishing agent layer forming step.

FIG. 11 is a schematic cross-sectional view illustrating an encapsulating step.

FIG. 12 is a schematic plan view illustrating a fire extinguishing material according to a fourth embodiment.

FIG. 13 is a schematic plan view illustrating a modification of the fire extinguishing material.

FIG. 14 is a schematic plan view illustrating a modification of the fire extinguishing material.

### DESCRIPTION OF THE EMBODIMENTS

Referring to the drawings, some embodiments of the present disclosure will be described in detail. In the following description, like or equivalent elements are designated by like reference signs to omit repeated explanations.

### First Embodiment

### <Fire Extinguishing Material Roll>

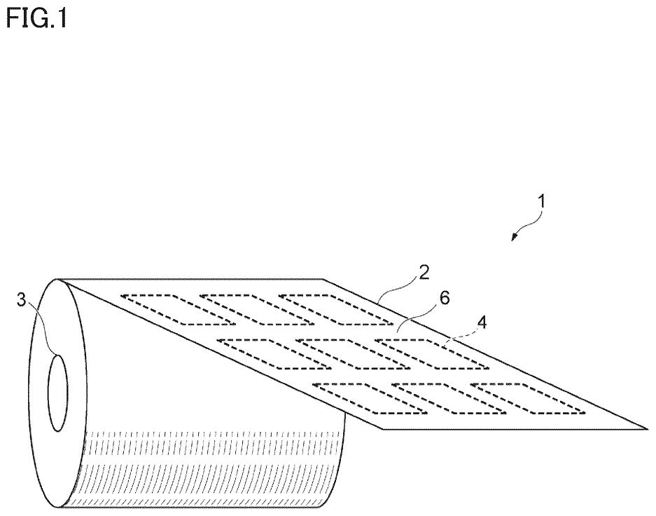

FIG. 1 is a schematic perspective view illustrating a fire extinguishing material roll according to a first embodiment. As shown in FIG. 1, a fire extinguishing material roll 1 according to the present embodiment is formed by winding a fire extinguishing material 2 in a roll. For example, the fire extinguishing material roll 1 may be formed by winding the fire extinguishing material 2 around a winding core 3.

### <Fire Extinguishing Material>

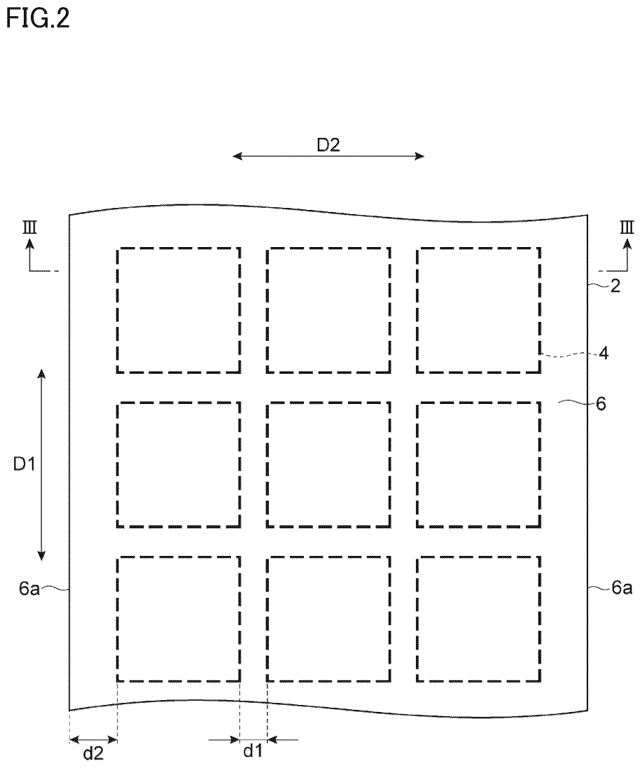

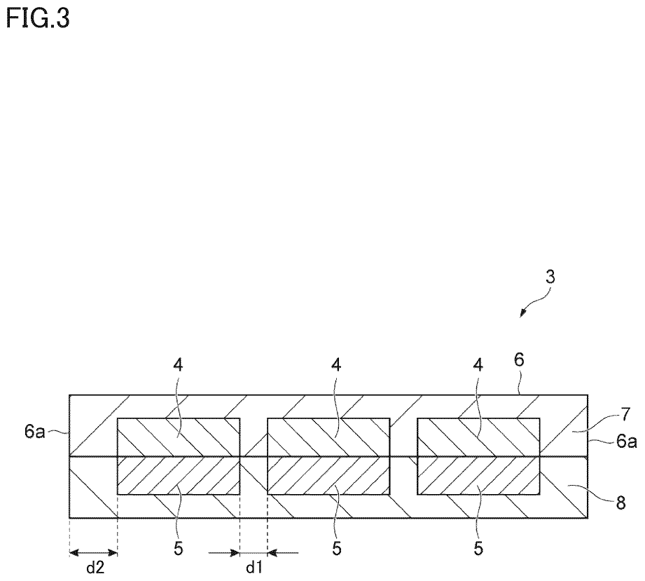

FIG. 2 is a schematic plan view illustrating the fire extinguishing material according to the first embodiment. FIG. 3 is a schematic cross-sectional view taken along the line III-III of FIG. 2. As shown in FIGS. 1 to 3, the fire extinguishing material 2 according to the present embodiment includes multiple parts of a fire extinguishing agent layer 4 arranged at intervals from each other, multiple parts of a substrate 5 laminated on the respective multiple parts of the fire extinguishing agent layer 4, and a packaging material 6 individually encapsulating the multiple parts of the fire extinguishing agent layer 4. The expression “individually encapsulating the multiple parts of the fire extinguishing agent layer 4” refers to the multiple parts of the fire extinguishing agent layer 4 being individually sealed. Therefore, in the fire extinguishing material 2, each of the multiple parts of the fire extinguishing agent layer 4 is encapsulated (sealed) in the packaging material 6 separately from (independently of) other parts of the fire extinguishing agent layer 4.

### (Fire Extinguishing Agent Layer)

The multiple parts of the fire extinguishing agent layer 4 (hereinafter may also be simply referred to as fire extinguishing agent layer 4) are obtained by molding a composition containing a fire extinguishing agent and a binder resin (fire extinguishing agent layer-forming composition). Using a binder resin, properties of the fire extinguishing agent can be easily maintained, and the frequency of replacing the fire extinguishing material 2 can be reduced. The fire extinguishing agent layer-forming composition may further contain a liquid medium in addition to the fire extinguishing agent and the binder resin.

As the fire extinguishing agent, various organic or inorganic salts can be used singly or being mixed with each other. Examples of the organic salts include potassium salts, sodium salts, and ammonium salts. As the organic salts, potassium salts can be used preferably. Examples of the organic potassium salts include carboxylic acid potassium salts such as potassium acetate, potassium citrate (monopotassium citrate, dipotassium citrate, and tripotassium citrate), potassium tartrate, potassium lactate, potassium oxalate, and potassium maleate. Of these, potassium acetate or potassium citrate can be used preferably from the perspective of utility for negative catalytic effects on combustion. The potassium citrate can be selected from monopotassium citrate, dipotassium citrate, tripotassium citrate, etc., and hydrates of these may also be used.

Examples of the inorganic salts include potassium salts and sodium salts. As the inorganic salts, potassium salts can be used preferably. Examples of the inorganic potassium salts include, potassium tetraborate, potassium carbonate, potassium hydrogen carbonate, potassium dihydrogen phosphate, and dipotassium hydrogen phosphate. Of these, potassium hydrogen carbonate can be used preferably from the perspective of utility for negative catalytic effects on combustion.

The fire extinguishing agent may contain a compound having an oxidizing effect. The compound having an oxidizing effect may be a chlorate such as potassium chlorate, sodium chlorate, strontium chlorate, ammonium chlorate, or magnesium chlorate. These can generate aerosols from the potassium salt when exposed to the thermal energy of a fire.

As the binder resin, thermoplastic resins and thermosetting resins can be used. Examples of the thermoplastic resins include polyolefin-based resins such as polypropylene-based resins, polyethylene-based resins, poly(1-)butene-based resins, and polypentene-based resins; polystyrene-based resins, acrylonitrile-butadiene-styrene-based resins, methyl methacrylate-butadiene-styrene resin, ethylene-vinyl acetate resin, ethylene-propylene resin, polycarbonate-based resins, polyphenylene ether-based resins, acrylic resins, polyamide-based resins, polyvinyl chloride-based resins, polyvinyl alcohol (PVA), and polyvinyl butyral (PVB). Examples of the thermosetting resins include rubbers such as natural rubber (NR), isoprene rubber (IR), butadiene rubber (BR), 1,2-polybutadiene rubber (1,2-BR), styrene-butadiene rubber (SBR), chloroprene rubber (CR), nitrile rubber (NBR), butyl rubber (IIR), ethylene-propylene rubber (EPR, EPDM), chlorosulfonated polyethylene (CSM), acrylic rubber (ACM, ANM), epichlorohydrin rubber (CO, ECO), multi-vulcanized rubber (T), silicone rubber (Q), fluororubber (FKM, FZ), and urethane rubber (U); polyurethane resin, phenolic resin, epoxy resin, and polyvinyl ether (PMVE)-maleic anhydride resin. The binder resin may contain a curing agent component.

The parts of the fire extinguishing agent layer 4 may contain colorants, antioxidants, flame retardants, inorganic fillers, etc., and from the perspective of stability of properties, may also contain additives such as surfactants, silane coupling agents, and antiblocking agents. These components can be adequately selected according to the composition of the fire extinguishing agent layer 4 and the type of the binder resin thereof.

The content of the fire extinguishing agent in the fire extinguishing agent layer 4 (relative to the total mass of the fire extinguishing agent layer 4) may be 70 mass % or more and 97 mass % or less, or may preferably be 80 mass % or more and 95 mass % or less, and more preferably be 85 mass % or more and 92 mass % or less. If the content of the fire extinguishing agent is 70 mass % or more, excellent fire extinguishing performance can be easily achieved. If the content of the fire extinguishing agent is 97 mass % or less, deliquescence of the salt can be easily suppressed, and a uniform fire extinguishing agent layer can be easily formed.

The thickness of the fire extinguishing agent layer 4 can be appropriately determined according to the amount of the fire extinguishing agent to be formulated. The thickness of the fire extinguishing agent layer 4 may be, for example, 1 mm or less, or may preferably be 30 μm to 1,000 μm, more preferably be 100 μm to 500 μm, and even more preferably be 150 μm to 500 μm.

The liquid medium may be an organic solvent. The organic solvent may be a water-soluble solvent, examples of which include alcohols such as methanol, ethanol, isopropyl alcohol, and n-propyl alcohol; ketones such as acetone and methyl ethyl ketone; glycols such as ethylene glycol and diethylene glycol; and glycol ethers such as N-methylpyrrolidone (NMP), tetrahydrofuran, and butyl cellosolve. From the perspective of the fire extinguishing agent having deliquescence, the liquid medium may be an alcohol solvent and, specifically, may be an isopropyl alcohol.

The amount of the liquid medium may be adequately adjusted according to the method of using the fire extinguishing agent layer-forming composition, but may be 40 mass % or more and 95 mass % or less relative to the total mass of the fire extinguishing agent layer-forming composition.

### (Substrate)

The multiple parts of the substrate 5 (hereinafter may also be simply referred to as substrate 5) are preferably parts of a resin substrate in light of the fact that the flame temperature is generally around 700° C. to 900° C. Examples of the material of the substrate 5 include polyolefins (LLDPE, PP, COP, CPP, etc.), polyesters (PET, etc.), fluororesins (PTFE, ETFE, EFEP, PFA, FEP, PCTFE, etc.), PVC, PVA, acrylic resins, epoxy resins, polyamides, and polyimides. As long as these resins are used, heat can create holes. If a material having transparency is selected for the substrate 5, exterior of the fire extinguishing material 2 can be easily inspected, or the time it needs to be replaced can be easily verified. The substrate 5 may contain the fire extinguishing agents mentioned above. From the perspective of adjusting water vapor permeability, the substrate 5 may be provided with a vapor deposition layer (alumina deposition layer or silica deposition layer) having water vapor barrier properties.

The thickness, breaking strength, etc. of the substrate 5 can be adequately selected according to the heat release and impact at the time of fire, space allowed, and the like. For example, a thick substrate 5 may achieve high strength or rigidity and a highly flat form, and can be easily handled. A thin substrate 5 may allow the fire extinguishing material 2 to be placed in a narrow space, and may shorten the time taken before the start of fire extinction because holes can be created in a short time. For example, the thickness of the substrate may be 4.5 μm or more and 100 μm or less, or may preferably be 12 μm or more and 50 μm or less. The substrate 5 may be a laminate of multiple substrates. The substrate 5 may be adhered to the fire extinguishing agent layer 4 via an adhesive layer.

### (Packaging Material)

The packaging material 6 is constituted of encapsulating films in which the multiple parts of the fire extinguishing agent layer 4 are individually encapsulated. The packaging material 6 is formed into a long shape (tape shape). The direction in which the packaging material 6 is elongated is referred to as length direction D1, and the direction perpendicular to the length direction D1 is referred to as width direction D2. The packaging material 6 extends in a sheet shape along the length direction D1 and the width direction D2.

The packaging material 6 has a first film 7 and a second film 8. The first and second films 7 and 8 are welded together sandwiching the multiple parts of the fire extinguishing agent layer 4 and the multiple parts of the substrate 5 therebetween. Specifically, the first film 7 is disposed on the side of the multiple parts of the fire extinguishing agent layer 4 corresponding to the respective multiple parts of the substrate 5, and welded to the multiple parts of the fire extinguishing agent layer 4. The second film 8 is disposed on the side of the multiple parts of the substrate 5 corresponding to the respective multiple parts of the fire extinguishing agent layer 4, and welded to the multiple parts of the substrate 5. The first and second films 7 and 8 are welded together between the multiple parts of the fire extinguishing agent layer 4 (between the multiple parts of the substrate 5) and on the outside of the multiple parts of the fire extinguishing agent layer 4 (on the outside of the multiple parts of the substrate 5). Thus, the packaging material 6 individually encapsulates the multiple parts of the fire extinguishing agent layer 4.

Any resin film can be used for the first and second films 7 and 8. Examples of the resin used for the first and second films 7 and 8 include polyolefin resins, polyester resins, fluororesins, vinyl resins, acrylic resins, epoxy resins, polyamides, polyimides, urethane resins, styrene-based resins, polycarbonates, ketone resins, sulfonic resins, and cellulose-based resins.

It is preferable that the first and second films 7 and 8 have water vapor barrier properties, and the water vapor permeability (under 40° C./90% RH according to JIS K 7129) may be 10 g/m²/day or less, or may preferably be 1 g/m²/day or less. From the perspective of adjusting water vapor permeability, the first and second films 7 and 8 having water vapor permeability may be a polyester resin layer (e.g., PET layer) including an inorganic metal oxide deposition layer such as an alumina deposition layer and silica deposition layer, or a metal foil such as an aluminum foil. If the water vapor barrier layer includes a metal oxide deposition layer, the metal oxide deposition layer may be located facing the fire extinguishing agent layer 4.

The packaging material 6 individually encapsulates the multiple parts of the fire extinguishing agent layer 4 so as to arrange them in the length direction D1 and the width direction D2. Specifically, the multiple parts of the fire extinguishing agent layer 4 are arrayed in the length direction D1 and the width direction D2 so as to form a lattice pattern (grid pattern). The number of arrays of the multiple parts of the fire extinguishing agent layer 4 in the length and width directions D1 and D2 should not be specifically limited.

The packaging material 6 may individually encapsulate the multiple parts of the fire extinguishing agent layer 4 such that a shortest distance d1 between adjacent parts of the fire extinguishing agent layer 4 will be 10 mm or more, from the perspective of suppressing mutual reaction of the adjacent parts of the fire extinguishing agent layer 4 and suppressing performance deterioration of the fire extinguishing agent layer 4 over a long period of time. In other words, the shortest distance d1 between adjacent parts of the fire extinguishing agent layer 4 can be 10 mm or more. The shortest distance d1 between adjacent parts of the fire extinguishing agent layer 4 may be 20 mm or more.

From the perspective of suppressing performance deterioration of the fire extinguishing agent layer over a long period of time, the packaging material 6 may individually encapsulate the multiple parts of the fire extinguishing agent layer 4 such that a shortest distance d2 from the multiple parts of the fire extinguishing agent layer 4 to an edge 6a of the packaging material 6 will be 5 mm or more. In other words, the shortest distance d2 from the multiple parts of the fire extinguishing agent layer 4 to the edge 6a of the packaging material 6 can be 5 mm or more. The shortest distance d2 from the multiple parts of the fire extinguishing agent layer 4 to the edge 6a of the packaging material 6 may be 10 mm or more.

### <Method of Producing Fire Extinguishing Material>

Next, a method of producing the fire extinguishing material 2 will be described. The method of producing the fire extinguishing material 2 includes a fire extinguishing agent layer forming step in which multiple parts of the fire extinguishing agent layer 4 containing a fire extinguishing agent are formed, and an encapsulating step in which the multiple parts of the fire extinguishing agent layer 4 are individually encapsulated in the packaging material 6 at intervals from each other and. The method of producing the fire extinguishing material 2 may include a winding step in which the fire extinguishing material 2 including the multiple parts of the fire extinguishing agent layer 4 individually encapsulated in the packaging material 6 is wound up in a roll.

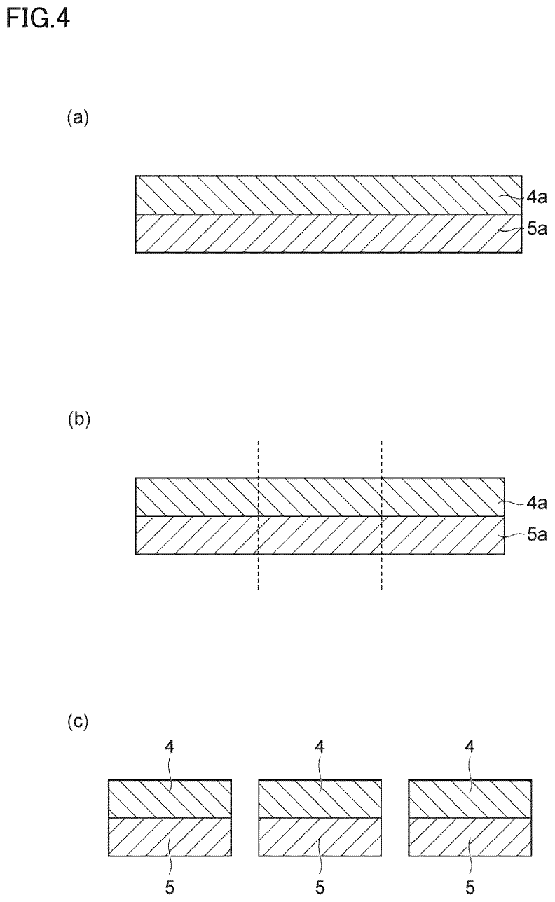

FIGS. 4(a), 4(b) and 4(c) are schematic cross-sectional views illustrating the fire extinguishing agent layer forming step. As shown in FIG. 4(a), in the fire extinguishing agent layer forming step, a fire extinguishing agent layer-forming composition 4a for forming a fire extinguishing agent layer 4 is applied to a substrate 5a. For example, the fire extinguishing agent layer-forming composition 4a may be applied using a wet coating method. Examples of the wet coating method include a comma coating method, dip coating method, curtain coating method, spin coating method, and sponge roll method. The fire extinguishing agent layer-forming composition 4a is dried after being applied to the substrate 5a. The drying temperature of the fire extinguishing agent layer-forming composition 4a is not specifically limited but may be, for example, 60 to 100° C. After being dried, the fire extinguishing agent layer-forming composition 4a together with the substrate 5a is cut, as shown in FIGS. 4(b) and 4(c), into multiple sheet-like parts having a desired shape. For example, these parts of the fire extinguishing agent layer-forming composition 4a and the substrate 5a may be obtained by slitting, cutting or punching. Consequently, multiple parts of the fire extinguishing agent layer 4 laminated on respective multiple parts of the substrate 5 are formed.

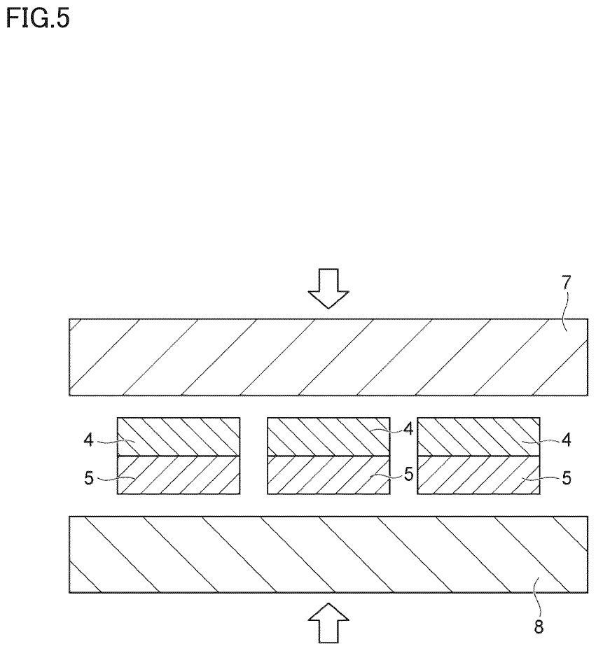

FIG. 5 is a schematic cross-sectional view illustrating the encapsulating step. As shown in FIG. 5, in the encapsulating step, the first and second films 7 and 8 are welded together sandwiching therebetween the multiple parts of the fire extinguishing agent layer 4 separated from each other. For example, in the welding, the multiple parts of the fire extinguishing agent layer 4 may be sandwiched between the first and second films 7 and 8 from both the multiple parts of the fire extinguishing agent layer 4 side and the multiple parts of the substrate 5 side using a roll-to-roll laminator or the like, and the first and second films 7 and 8 may be welded together using a thermocompression method or the like. Thus, a fire extinguishing material 2 is formed in which the multiple parts of the fire extinguishing agent layer 4 are separated from each other and individually encapsulated in the packaging material 6.

In the winding step, the fire extinguishing material 2 is wound about the winding core 3 using the roll-to-roll laminator or the like used in the encapsulating step. Consequently, a fire extinguishing material roll 1 is formed.

As described above, in the fire extinguishing material 2 of the present embodiment, the multiple parts of the fire extinguishing agent layer 4 arranged at intervals from each other are individually encapsulated in the packaging material 6 to suppress chain reaction of the fire extinguishing agent between the multiple parts of the fire extinguishing agent layer 4. In other words, even if one part of the fire extinguishing agent layer 4 is consumed as a result of a reaction, other parts of the fire extinguishing agent layer 4 can remain unreacted. Furthermore, even if a portion of the packaging material 6 encapsulating one part of the fire extinguishing agent layer 4 is melted creating a hole, other parts of the fire extinguishing agent layer 4 can remain encapsulated in the packaging material 6. Thus, the multiple parts of the fire extinguishing agent layer 4 can be reacted in a multi-stage manner, enabling handling of a multi-stage fire. In other words, a fire can be extinguished in a multi-stage manner.

In the fire extinguishing material 2, due to the fire extinguishing agent containing at least either of an organic salt and an inorganic salt, appropriate fire extinguishing performance can be achieved.

In the fire extinguishing material 2, due to the fire extinguishing agent containing an oxidizing compound, aerosols can be generated by receiving thermal energy from a fire.

In the fire extinguishing material 2, due to the fire extinguishing agent containing potassium citrate and potassium chlorate, appropriate fire extinguishing performance can be achieved.

In the fire extinguishing material 2, due to the fire extinguishing agent layer 4 containing a binder, properties of the fire extinguishing agent can be easily maintained, and the frequency of replacing the fire extinguishing material 2 can be reduced.

In the fire extinguishing material 2, due to the content of the fire extinguishing agent in the fire extinguishing agent layer 4 being 70 mass % or more, preferably 80 mass % or more, and more preferably 85 mass % or more, excellent fire extinguishing performance can be easily achieved. Also, due to the content of the fire extinguishing agent in the fire extinguishing agent layer 4 being 97 mass % or less, preferably 95 mass % or less, and more preferably 92 mass % or less, deliquescence of the fire extinguishing agent can be easily suppressed, and a uniform fire extinguishing agent layer 4 can be easily formed.

In the fire extinguishing material 2, due to the multiple parts of the fire extinguishing agent layer 4 being arranged in the length direction D1 of the packaging material 6, a multi-stage fire in the length direction D1 of the packaging material 6 can be handled. Also, due to the fire extinguishing material 2 cut and divided in the length direction D1 for use, the fire extinguishing material 2 can be formed into various shapes, enhancing installation flexibility.

In the fire extinguishing material 2, due to the parts of the fire extinguishing agent layer 4 being also arranged in the width direction D2 of the packaging material 6, a multi-stage fire in the width direction D2 of the packaging material 6 can be handled. Also, due to the fire extinguishing material 2 cut and divided in the width direction D2 for use, the fire extinguishing material 2 can be formed into various shapes, enhancing installation flexibility.

In the fire extinguishing material 2, due to the shortest distance d1 between adjacent parts of the fire extinguishing agent layer 4 being 10 mm or more, and preferably 20 mm or more, mutual reaction between adjacent parts of the fire extinguishing agent layer 4 can be suppressed. If the fire extinguishing material 2 is cut between adjacent parts of the fire extinguishing agent layer 4, ingress of the moisture that has permeated through the cut surface to the fire extinguishing agent layer 4 can be retarded. In particular, by cutting the fire extinguishing material 2 at the center between adjacent parts of the fire extinguishing agent layer 4, the distance from the cut surface to the fire extinguishing agent layer 4 can be 5 mm or more, and preferably 10 mm or more, and therefore ingress of the moisture that has permeated through the cut surface to the fire extinguishing agent layer 4 can be further retarded. Therefore, even if a fire extinguishing agent having deliquescence is used, performance deterioration of the fire extinguishing agent layer 4 can be suppressed over a long period of time.

In the fire extinguishing material 2, due to the shortest distance d2 from the multiple parts of the fire extinguishing agent layer 4 to the edge 6a of the packaging material 6 being 5 mm or more, and preferably 10 mm or more, moisture that has penetrated from the edge 6a of the packaging material 6 is less likely to reach the fire extinguishing agent layer 4. Therefore, even if a fire extinguishing agent having deliquescence is used, performance deterioration of the fire extinguishing agent layer 4 can be suppressed over a long period of time.

In the fire extinguishing material 2, due to the multiple parts of the fire extinguishing agent layer 4 being laminated with the respective multiple parts of the substrate 5, handleability of the multiple parts of the fire extinguishing agent layer 4 is improved when encapsulating them individually in the packaging material 6.

In the fire extinguishing material 2, due to the packaging material 6 including the first film 7 and the second film 8 welded to the first film 7 so as to sandwich the multiple parts of the fire extinguishing agent layer 4 therebetween, the fire extinguishing material 2 can be easily produced.

In the fire extinguishing material 2, due to the first and second films 7 and 8 having a water vapor permeability of 10 g/m²/day or less, and preferably 1 g/m²/day or less, even if a fire extinguishing agent having deliquescence is used, performance deterioration of the fire extinguishing agent layer 4 can be suppressed over a long period of time.

In the fire extinguishing material roll 1 of the present embodiment, due to the fire extinguishing material 2 being wound up in a roll, storage and handleability of the fire extinguishing material 2 are improved.

In the method of producing a fire extinguishing material of the present embodiment, multiple parts of the fire extinguishing agent layer 4 containing a fire extinguishing agent are formed, and the multiple parts of the fire extinguishing agent layer 4 are individually encapsulated in a packaging material 6 at intervals from each other, and therefore a fire extinguishing material 2 capable of handling a multi-stage fire can be produced.

In the method of producing a fire extinguishing material, multiple parts of the fire extinguishing agent layer 4 can be easily formed by applying the fire extinguishing agent layer-forming composition 4a to the substrate 5a, and cutting the fire extinguishing agent layer-forming composition 4a and the substrate 5a together.

In the method of producing a fire extinguishing material, multiple parts of the fire extinguishing agent layer 4 can be individually encapsulated with ease by welding the first and second films 7 and 8 together so as to sandwich the multiple parts of the fire extinguishing agent layer 4 therebetween.

In the method of producing a fire extinguishing material, the fire extinguishing material roll 1 can be produced by winding the fire extinguishing material 2 in a roll.

### Second Embodiment

Next, a second embodiment will be described. The second embodiment is basically similar to the first embodiment except that part of the structure of the fire extinguishing material and part of the method of producing a fire extinguishing material are different from those of the first embodiment. Therefore, description hereinafter will be focused on the differences from the first embodiment to omit description of matters similar to those of the first embodiment.

### <Fire Extinguishing Material>

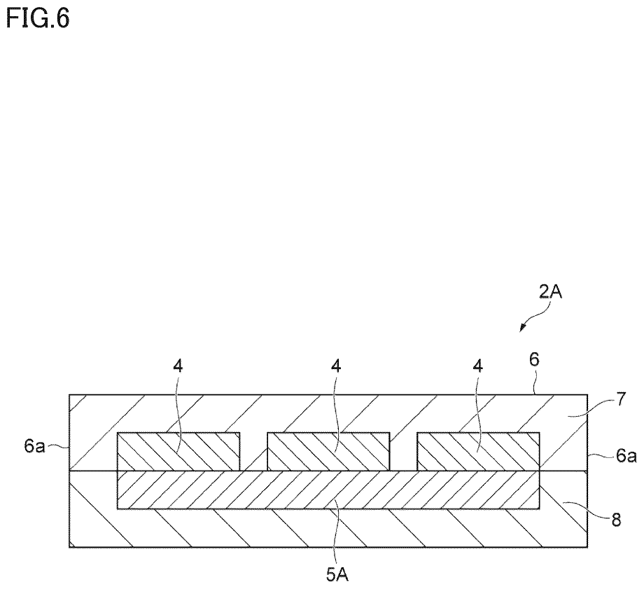

FIG. 6 is a schematic cross-sectional view illustrating a fire extinguishing material according to the second embodiment. As shown in FIG. 6, a fire extinguishing material 2A according to the present embodiment includes multiple parts of a fire extinguishing agent layer 4 arranged at intervals from each other, a substrate 5A laminated on the multiple parts of the fire extinguishing agent layer 4, and a packaging material 6 individually encapsulating the multiple parts of the fire extinguishing agent layer 4. Specifically, in the fire extinguishing material 2A, multiple parts of the fire extinguishing agent layer 4 are laminated on a single substrate 5A, maintaining the state in which the multiple parts of the fire extinguishing agent layer 4 are arranged at intervals from each other on the single substrate 5A.

### <Method of Producing Fire Extinguishing Material>

Next, a method of producing the fire extinguishing material 2A will be described. The method of producing the fire extinguishing material 2A includes a fire extinguishing agent layer forming step in which multiple parts of the fire extinguishing agent layer 4 containing a fire extinguishing agent are formed, and an encapsulating step in which the multiple parts of the fire extinguishing agent layer 4 are individually encapsulated in a packaging material 6 at intervals from each other and. The method of producing the fire extinguishing material 2A may include a winding step in which the fire extinguishing material 2A including the multiple parts of the fire extinguishing agent layer 4 individually encapsulated in the packaging material 6 is wound up in a roll.

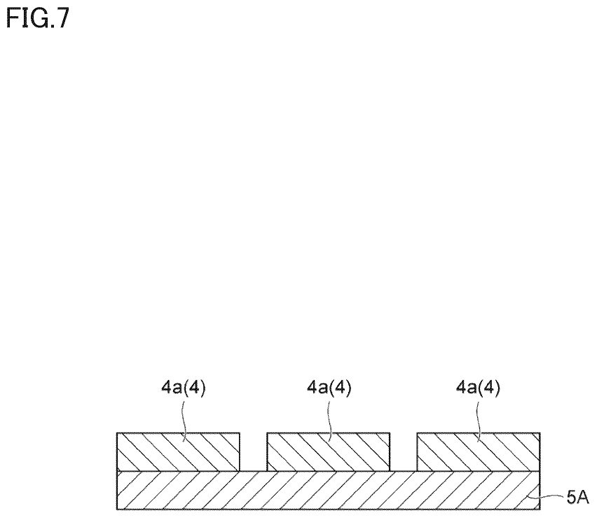

FIG. 7 is a schematic cross-sectional view illustrating the fire extinguishing agent layer forming step. As shown in FIG. 7, in the fire extinguishing agent layer forming step, a fire extinguishing agent layer-forming composition 4a for forming a fire extinguishing agent layer 4 is intermittently applied to the substrate 5A. For example, the intermittent application of the fire extinguishing agent layer-forming composition 4a can be performed by nozzle-controlled die coating with intermittent liquid supply operation, gravure printing, screen printing, etc. The fire extinguishing agent layer-forming composition 4a is dried after being intermittently applied to the substrate 5A. The drying temperature of the fire extinguishing agent layer-forming composition 4a is not specifically limited but may be, for example, 60 to 100° C. Thus, multiple parts of the fire extinguishing agent layer 4 having a desired shape are formed at intervals from each other on the substrate 5A.

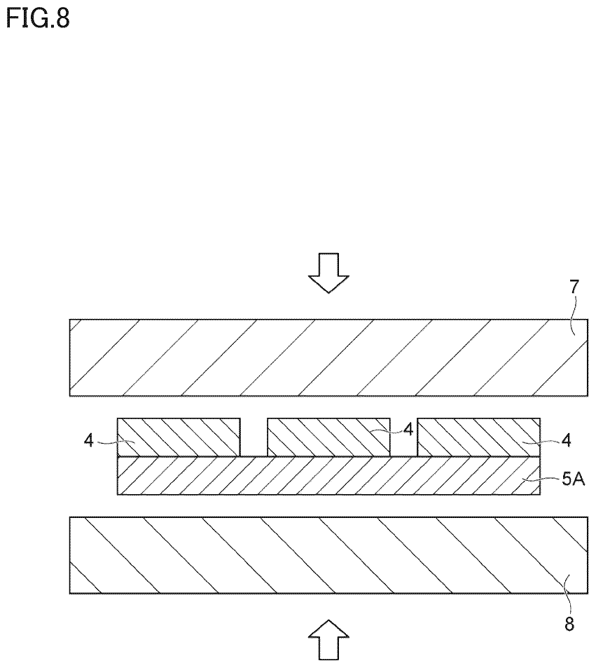

FIG. 8 is a schematic cross-sectional view illustrating the encapsulating step. As shown in FIG. 8, in the encapsulating step, the substrate 5A to which the fire extinguishing agent layer-forming composition 4a has been intermittently applied is encapsulated in the packaging material 6. Specifically, a first film 7 and a second film 8 are welded together so as to sandwich therebetween the substrate 5A to which the fire extinguishing agent layer-forming composition 4a has been intermittently applied. For example, in the welding, the multiple parts of the fire extinguishing agent layer 4 and the substrate 5A may be sandwiched between the first and second films 7 and 8 from both the multiple parts of the fire extinguishing agent layer 4 side and the substrate 5A side using a roll-to-roll laminator or the like, and the first and second films 7 and 8 may be welded together using a thermocompression method or the like. Consequently, a fire extinguishing material 2A is formed in which the multiple parts of the fire extinguishing agent layer 4 are separated from each other and individually encapsulated in the packaging material 6.

As described above, in the fire extinguishing material 2A of the present embodiment, due to the multiple parts of the fire extinguishing agent layer 4 being laminated on the substrate 5A, handleability of the multiple parts of the fire extinguishing agent layer 4 is improved when encapsulating them individually in the packaging material 6. Furthermore, misalignment in positional relationship between the multiple parts of the fire extinguishing agent layer 4 can be suppressed when encapsulating them individually in the packaging material 6.

In the method of producing a fire extinguishing material of the present embodiment, multiple parts of the fire extinguishing agent layer 4 can be formed by intermittently applying the fire extinguishing agent layer-forming composition 4a to the substrate 5A. By encapsulating the substrate 5A, to which the fire extinguishing agent layer-forming composition 4a has been intermittently applied, in the packaging material 6, the multiple parts of the fire extinguishing agent layer 4 can be individually encapsulated with ease.

In the method of producing a fire extinguishing material, multiple parts of the fire extinguishing agent layer 4 can be individually encapsulated with ease by welding the first and second films 7 and 8 together so as to sandwich therebetween the substrate 5A to which the fire extinguishing agent layer-forming composition 4a has been intermittently applied.

### Third Embodiment

Next, a third embodiment will be described. The third embodiment is basically similar to the first embodiment except that part of the structure of the fire extinguishing material and part of the method of producing a fire extinguishing material are different from those of the first embodiment. Therefore, description hereinafter will be focused on the differences from the first embodiment to omit description of matters similar to those of the first embodiment.

### <Fire Extinguishing Material>

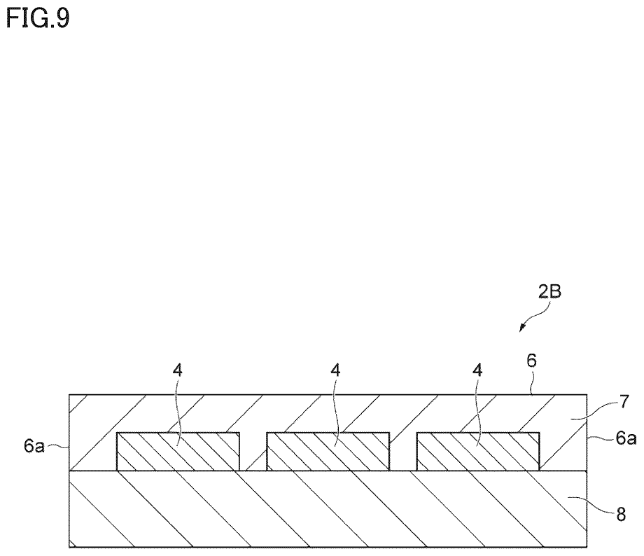

FIG. 9 is a schematic cross-sectional view illustrating a fire extinguishing material according to the third embodiment. As shown in FIG. 9, a fire extinguishing material 2B according to the present embodiment includes multiple parts of a fire extinguishing agent layer 4 arranged at intervals from each other, and a packaging material 6 individually encapsulating the multiple parts of the fire extinguishing agent layer 4. Specifically, the fire extinguishing material 2B is not provided with a substrate, and the multiple parts of the fire extinguishing agent layer 4 are directly encapsulated in the packaging material 6.

### <Method of Producing Fire Extinguishing Material>

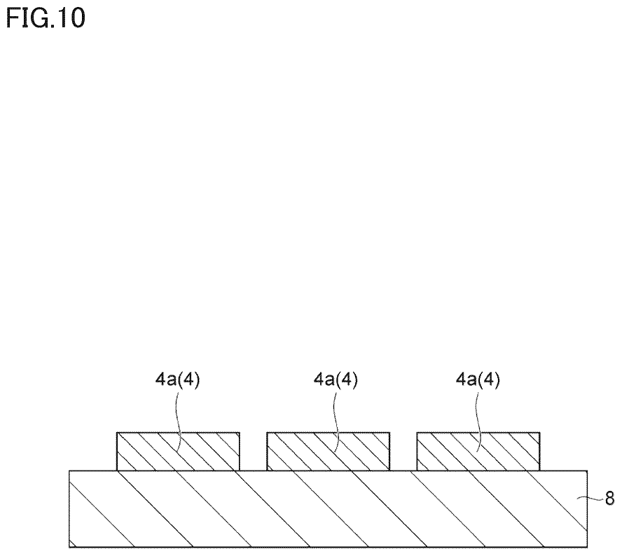

FIG. 10 is a schematic cross-sectional view illustrating the fire extinguishing agent layer forming step. As shown in FIG. 10, in the fire extinguishing agent layer forming step, a fire extinguishing agent layer-forming composition 4a for forming a fire extinguishing agent layer 4 is intermittently applied to a second film 8. For example, the intermittent application of the fire extinguishing agent layer-forming composition 4a can be performed by nozzle-controlled die coating with intermittent liquid supply operation, gravure printing, screen printing, etc. The fire extinguishing agent layer-forming composition 4a is dried after being intermittently applied to the second film 8. The drying temperature of the fire extinguishing agent layer-forming composition 4a is not specifically limited but may be, for example, 60 to 100° C. Thus, multiple parts of the fire extinguishing agent layer 4 having a desired shape are formed at intervals from each other on the second film 8.

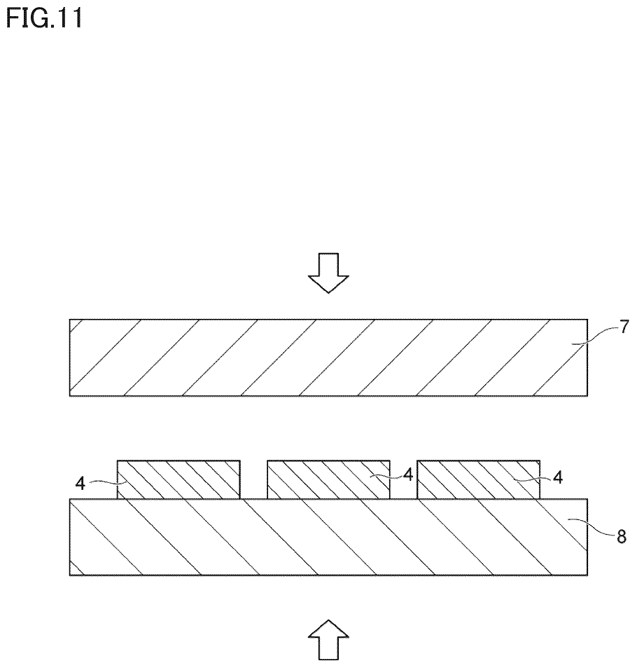

FIG. 11 is a schematic cross-sectional view illustrating the encapsulating step. As shown in FIG. 11, in the encapsulating step, the multiple parts of the fire extinguishing agent layer 4 are individually encapsulated by a first film 7 and the second film 8 to which the fire extinguishing agent layer-forming composition 4a has been intermittently applied. Specifically, the first and second films 7 and 8 are welded together so as to sandwich therebetween the multiple parts of the fire extinguishing agent layer 4 formed on the second film 8. For example, in the welding, the first film 7 may be overlapped with the multiple parts of the fire extinguishing agent layer 4 side surface of the second film 8 using a roll-to-roll laminator or the like, and the first and second films 7 and 8 may be welded together using a thermocompression method or the like. Consequently, a fire extinguishing material 2B is formed in which the multiple parts of the fire extinguishing agent layer 4 are separated from each other and individually encapsulated in the packaging material 6.

### Fourth Embodiment

Next, a fourth embodiment will be described. The fourth embodiment is basically similar to the first embodiment except that perforations are formed in the fire extinguishing material. Therefore, description hereinafter will be focused on the differences from the first embodiment to omit description of matters similar to those of the first embodiment.

### <Fire Extinguishing Material>

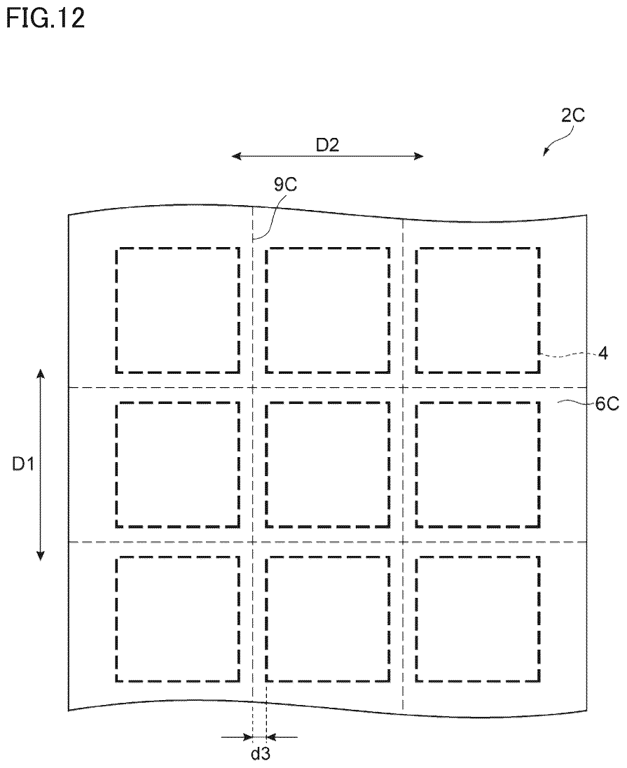

FIG. 12 is a schematic plan view illustrating a fire extinguishing material according to the fourth first embodiment. As shown in FIG. 12, a fire extinguishing material 2C according to the present embodiment includes multiple parts of a fire extinguishing agent layer 4 arranged at intervals from each other, multiple parts of a substrate 5 (see FIG. 3) laminated on the respective multiple parts of the fire extinguishing agent layer 4, and a packaging material 6C individually encapsulating the multiple parts of the fire extinguishing agent layer 4. The packaging material 6C has perforations 9C formed between adjacent parts of the fire extinguishing agent layer 4. The perforations 9C, which are slit lines formed by intermittently cutting the packaging material 6C, serve as auxiliary lines when cutting the fire extinguishing material 2C. The perforations 9C are formed passing the center between adjacent parts of the fire extinguishing agent layer 4. A shortest distance d3 from a part of the fire extinguishing agent layer 4 closest to a perforation 9C to the perforation 9C may be, for example, 5 mm or more, and may preferably be 10 mm or more.

The perforations 9C may be formed between all adjacent parts of the fire extinguishing agent layer 4, or may be formed between some of adjacent parts of the fire extinguishing agent layer 4. The packaging material 6C may have one or more perforations 9C extending in the length direction D1, or may have one or more perforations 9C extending in the width direction D2, or may have both of these. If the perforations are applied to the fire extinguishing material 2A of the second embodiment, the perforations may be formed not only in the packaging material 6 but also in the substrate 5A.

When producing the fire extinguishing material 2C, the perforations 9C can be formed in the packaging material 6C, for example, after the fire extinguishing agent layer-forming step and the encapsulating step and before the winding step.

As described above, in the fire extinguishing material 2C of the present embodiment, due to the packaging material 6C having the perforations 9C formed between adjacent parts of the fire extinguishing agent layer 4, the fire extinguishing material 2C can be easily cut between adjacent parts of the fire extinguishing agent layer 4.

Also, due to the shortest distance d3 from a part of the fire extinguishing agent layer 4 closest to a perforation 9C to the perforation 9C being 5 mm or more, and preferably 10 mm or more, if the fire extinguishing material 2C is cut along the perforation 9C, ingress of the moisture that has permeated through the cut surface to the fire extinguishing agent layer 4 can be retarded. Therefore, even if a fire extinguishing agent having deliquescence is used, performance deterioration of the fire extinguishing agent layer 4 can be suppressed over a long period of time.

Some embodiments of the present disclosure have been described so far; however, the present disclosure should not be construed as being limited to the above embodiments, but may be modified within a scope not changing the gist of the claims, or may be applied to other subjects.

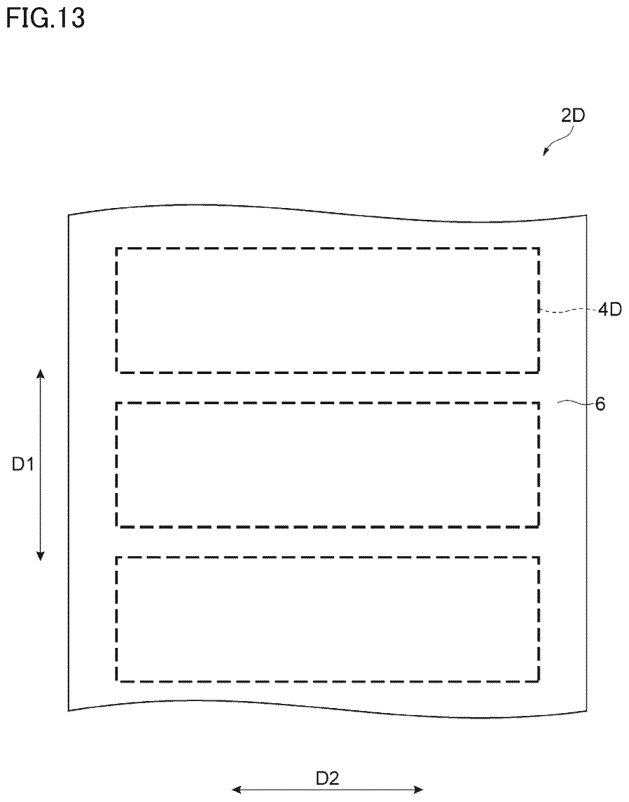

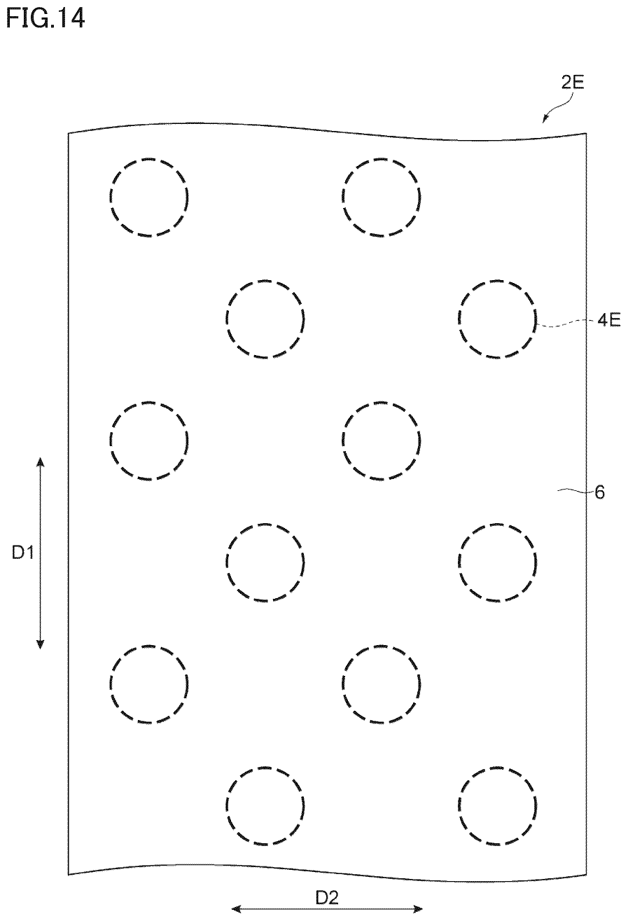

For example, the above embodiments have been described assuming that the multiple parts of the fire extinguishing agent layer are arranged in the length direction D1 and the width direction D2; however, the arrangement of the multiple parts of the fire extinguishing agent layer should not be specifically limited. For example, as in a fire extinguishing material 2D shown in FIG. 13, multiple parts of a fire extinguishing agent layer 4D may be arranged only in the length direction D1. Also, as in a fire extinguishing material 2E shown in FIG. 14, multiple parts of a fire extinguishing agent layer 4E may be arranged in a staggered pattern. FIGS. 13 and 14 are schematic plan views illustrating modifications of the fire extinguishing material.

The above embodiments have been described taking examples in which the fire extinguishing layer has been formed into a rectangular shape. However, the shape of the fire extinguishing layer should not be specifically limited. For example, as in the fire extinguishing material 2E shown in FIG. 14, the fire extinguishing layer 4E may have a circular shape.

### EXAMPLES

The present disclosure will be described more specifically using the following examples; however, the present disclosure should not be limited to these examples.

### Example 1

### (Fire Extinguishing Agent Layer)

A fire extinguishing agent was prepared by crushing potassium chlorate and tripotassium citrate in an agate mortar to an average particle size D50 of 12 μm or less. The fire extinguishing agent was mixed with various materials in the following mixing ratio to obtain a fire extinguishing agent layer-forming composition.

| | |
|---|---|
| Fire extinguishing agent component: Mixture of | 87 parts by mass |
| potassium chlorate and tripotassium citrate | |
| Binder resin: Polyvinyl butyral resin solution | 81 parts by mass |
| (solution obtained by dissolving 11 parts | |
| by mass of polyvinyl butyral resin in 80 parts | |
| by mass of ethanol and 9 parts by mass of | |
| isopropyl alcohol) | |
| Silane coupling agent: X-12-1287A (manufactured | 4 parts by mass |
| by Shin-Etsu Chemical Co., Ltd.) | |
| Liquid medium: Ethanol | 87 parts by mass |

The fire extinguishing agent layer-forming composition was applied to one entire surface of a polyethylene terephthalate (PET) substrate (product name: E7002 manufactured by Toyobo Co., Ltd., thickness: 50 μm) using a comma coater so that the dry film thickness was 150 μm, and then the film was processed into sheet-like parts of 85 mm×128 mm using a slitter and a cutter.

### (Encapsulating Film)

Epoxy-urethane synthetic adhesives AD-393 and CAT-EP5 both manufactured by Toyo Ink Co., Ltd. and an isopropyl alcohol as a dilution solvent were mixed together in a mixing ratio of 15:1:25.7, followed by stirring for 1 minute to prepare a dry lamination adhesive with a solid content of 20 mass %.

The dry lamination adhesive was applied to the vapor-deposited layer side of GL-RD (aluminum deposited polyester film manufactured by Toppan Inc.) using a dry laminator, followed by drying in a drying oven set to 80° C. to form an adhesive layer with a dry coating amount of 2 g/m². Subsequently, using the second feed of the dry laminator, the corona-treated surface of an unstretched polypropylene film MC-S (manufactured by Mitsui Chemicals Tohcello Inc., thickness 30 μm) was laminated to the GL-RD to prepare an encapsulating film.

### (Encapsulation of Fire Extinguishing Agent Layer)

Front and rear fire extinguishing agent layer-encapsulating films were set to the unwinding section of a laminator (roll winding device was installed in VA-900 manufactured by Taisei Laminator Co., Ltd.), and then parts of a substrate, to which respective sheet-like processed parts of the fire extinguishing agent layer were applied, were arranged at 10 mm intervals from each other, and laminated with the encapsulating films by thermocompression lamination under the following conditions to obtain a fire extinguishing material.
Laminate roll temperature: 120° C.
Nip pressure: 0.3 MPa
Conveying speed: 3 m/min
Unwinding tension of encapsulating films: 6.5 N/100 m
Winding tension: 14 N/100 m

The fire extinguishing material after lamination was wound up in a roll, thereby obtaining a fire extinguishing material roll of Example 1.

### Example 2

Perforations were formed in the fire extinguishing material roll of Example using a rotary blade. The perforations were formed at a position passing through the center between adjacent parts of the fire extinguishing agent layer, with the cut portion being 2.7 mm and the uncut portion being 1 mm.

### Example 3

The fire extinguishing agent layer-forming composition of Example 1 was applied to one surface of a polyethylene terephthalate (PET) substrate (product name: E7002 manufactured by Toyobo Co., Ltd., thickness: 50 μm) using nozzle-controlled die coating with intermittent liquid supply operation to form a fire extinguishing agent layer with a 85 mm×128 mm pattern. The dry coating amount was similar to that of Example 1. The pattern was formed so that the uncoated area of the edge of the fire extinguishing agent layer was 10 mm wide.

A fire extinguishing material roll of Example 3 was prepared as in Example 1 by performing lamination using a laminator, except that the substrate with parts of the fire extinguishing agent layer applied in a pattern was overlapped with front and rear fire extinguishing agent layer-encapsulating films and the laminate roll temperature was set to 180° C.

### Example 4

A fire extinguishing material roll of Example 4 was prepared as in Example 3, except that intermittent coating was directly performed on the fire extinguishing agent layer-encapsulating films, instead of a substrate.

### Example 5

A fire extinguishing material roll of Example 5 was prepared as in Example 1, except that parts of a substrate, to which respective sheet-like processed parts of the fire extinguishing agent layer were applied, were arranged at 2 mm intervals from each other.

### Example 6

A fire extinguishing material roll of Example 6 was prepared as in Example 1, except that parts of a substrate, to which respective sheet-like processed parts of the fire extinguishing agent layer were applied, were arranged at 4 mm intervals from each other.

### Example 7

A fire extinguishing material roll of Example 7 was prepared as in Example 1, except that parts of a substrate, to which respective sheet-like processed parts of the fire extinguishing agent layer were applied, were arranged at 8 mm intervals from each other.

### Example 8

A fire extinguishing material roll of Example 8 was prepared as in Example 1, except that parts of a substrate, to which respective sheet-like processed parts of the fire extinguishing agent layer were applied, were arranged at 20 mm intervals from each other.

### Comparative Example 1

A substrate, to which the processed sheet-like parts of the fire extinguishing agent layer of Example 1 were applied, was prepared with the fire extinguishing agent layer exposed without being encapsulated in the encapsulating films, for use as a fire extinguishing material roll of Comparative Example 1.

### <Evaluation for Stability of Properties>

Evaluation samples, in each of which a 85 mm×128 mm sheet of the fire extinguishing agent layer was encapsulated by the encapsulating films with four sides sealed, were cut from the fire extinguishing material rolls of Examples 1 to 8 and Comparative Example 1, stored for 7 days under the conditions of 85° C./85% RH, and then a total light transmittance variation A was calculated from the difference in total light transmittance of the fire extinguishing agent layer before and after storage. A haze meter (BYK-Gardner Haze-Guard Plus, manufactured by BYK) was used for measuring the total light transmittance. The measurement was performed with the fire extinguishing agent layer fixed so that the light entering the integrating sphere from the light source passed through the fire extinguishing agent layer. If moisture absorption (deliquescence) occurs and the stability of properties decreases, transparency of the fire extinguishing material may increase. Therefore, by checking this variation A, the degree of deliquescence, i.e., the stability of properties, was evaluated. The evaluations were performed based on the following criteria. The evaluations are shown in Table 1.

$$Variation Δ = Total light transmittance after storage - Total light transmittance before storage$$

A: Variation Δ was less than 70.
B: Variation Δ was less than 70 but transparency was observed at the edge of the fire extinguishing agent layer.
C: Variation Δ was 70 or more.

TABLE 1

| | | | Spacing between | | |
|---|---|---|---|---|---|
| | | | parts of fire | | Stability |
| | | Perfo- | extinguishing | | of |
| | Coating | rations | agent layer | | properties |
| Ex. 1 | Comma coating | No | 10 | mm | A |
| Ex. 2 | Comma coating | Yes | 10 | mm | A |
| Ex. 3 | Die coating | No | 10 | mm | A |
| | (Intermittent coating) | | | | |
| Ex. 4 | Die coating | No | 10 | mm | A |
| | (Intermittent coating) | | | | |
| Ex. 5 | Comma coating | No | 2 | mm | B |
| Ex. 6 | Comma coating | No | 4 | mm | B |
| Ex. 7 | Comma coating | No | 8 | mm | B |
| Ex. 8 | Comma coating | No | 20 | mm | A |

| | | | | |
|---|---|---|---|---|
| Comp. | Comma coating | No | No packaging | C |
| Ex. 1 | | | | |

The fire extinguishing agent layers of the fire extinguishing material rolls of Examples 1 to 8 and Comparative Example 1 could all be cut to a desired size for use. The fire extinguishing materials of Examples 1 to 8 were all evaluated to be A or B, among which the fire extinguishing materials of Examples 1 to 4 and 8 had particularly excellent stability of properties because of having a larger interval, as 10 mm or more, between multiple parts of the fire extinguishing agent layer to provide a larger adhesion width between the encapsulating films when cut from the fire extinguishing materials, and because of being less likely to cause water permeation under high temperature and high humidity. On the other hand, in Comparative Example 1, deliquescence proceeded because of being not encapsulated in the encapsulating films, resulting in significantly poor stability of properties.

### REFERENCE SIGNS LIST

1 . . . Fire extinguishing material roll
2, 2A, 2B, 2C, 2D, 2E . . . Fire extinguishing material
3 . . . Winding core
4, 4D, 4E . . . Fire extinguishing agent layer
4a . . . Fire extinguishing agent layer-forming composition
5, 5A . . . Substrate
5a . . . Substrate
6, 6C . . . Packaging material
6a . . . Edge
7 . . . First film
8 . . . Second film
9C . . . Perforations
D1 . . . Length direction
D2 . . . Width direction
d1 . . . Shortest distance
d2 . . . Shortest distance
d3 . . . Shortest distance

1. A fire extinguishing material comprising
multiple parts of a fire extinguishing agent layer containing a fire extinguishing agent and arranged at intervals from each other; and
a packaging material individually encapsulating the multiple parts of the fire extinguishing agent layer,
wherein the fire extinguishing agent contains at least either of an organic salt and an inorganic salt,
a content of the fire extinguishing agent in the fire extinguishing agent layer is 70 mass % or more and 97 mass % or less,
the packaging material is formed into a long shape, and
the multiple parts of the fire extinguishing agent layer are arranged in a length direction of the packaging material.

2. The fire extinguishing material according to claim 1, wherein
the fire extinguishing agent contains a compound having an oxidizing effect.

3. The fire extinguishing material according to claim 1, wherein
the fire extinguishing agent contains potassium citrate and potassium chlorate.

4. The fire extinguishing material according to claim 1, wherein
the multiple parts of the fire extinguishing agent layer contain a binder.

5. The fire extinguishing material according to claim 1, wherein
the multiple parts of the fire extinguishing agent layer are also arranged in a width direction of the packaging material, the width direction being perpendicular to the length direction.

6. The fire extinguishing material according to claim 1, wherein
a shortest distance between adjacent parts of the fire extinguishing agent layer is 10 mm or more.

7. The fire extinguishing material according to claim 1, wherein
a shortest distance from the multiple parts of the fire extinguishing agent layer to an edge of the packaging material is 5 mm or more.

8. The fire extinguishing material according to claim 1, wherein
the packaging material has perforations formed between adjacent parts of the fire extinguishing agent layer.

9. The fire extinguishing material according to claim 8, wherein
a shortest distance from a part of the fire extinguishing agent layer closest to a perforation to the perforation is 5 mm or more.

10. The fire extinguishing material according to claim 1, further comprising
multiple parts of a substrate laminated on the respective multiple parts of the fire extinguishing agent layer.

11. The fire extinguishing material according to claim 1, further comprising
a substrate laminated on the multiple parts of the fire extinguishing agent layer.

12. The fire extinguishing material according to claim 1, wherein
the packaging material includes a first film and a second film welded to the first film so as to sandwich the multiple parts of the fire extinguishing agent layer therebetween.

13. The fire extinguishing material according to claim 12, wherein
the first film and the second film have a water vapor permeability of 10 g/m²/day or less.

14. A fire extinguishing material roll formed by winding in a roll the fire extinguishing material according to claim 1.

15. A method of producing a fire extinguishing material, comprising
a fire extinguishing agent layer forming step in which multiple parts of the fire extinguishing agent layer containing a fire extinguishing agent are formed; and
an encapsulating step in which the multiple parts of the fire extinguishing agent layer are individually encapsulated in a packaging material at intervals from each other.

16. The method of producing a fire extinguishing material according to claim 15, wherein
in the fire extinguishing agent layer forming step, a fire extinguishing agent layer-forming composition for forming the fire extinguishing agent layer is applied to a substrate, and the substrate and the fire extinguishing agent layer-forming composition are cut together.

17. The method of producing a fire extinguishing material according to claim 16, wherein
the packaging material includes a first film and a second film; and
in the encapsulating step, the first film and the second film are welded together so as to sandwich the multiple parts of the fire extinguishing agent layer therebetween.

18. The method of producing a fire extinguishing material according to claim 15, wherein
in the fire extinguishing agent layer forming step, a fire extinguishing agent layer-forming composition for forming the fire extinguishing agent layer is intermittently applied to a substrate; and
in the encapsulating step, the substrate to which the fire extinguishing agent layer-forming composition has been intermittently applied is encapsulated in the packaging material.

19. The method of producing a fire extinguishing material according to claim 18, wherein
the packaging material includes a first film and a second film; and
in the encapsulating step, the first film and the second film are welded together so as to sandwich therebetween the substrate to which the fire extinguishing agent layer-forming composition has been intermittently applied.

20. The method of producing a fire extinguishing material according to claim 15, further comprising
a winding step in which the fire extinguishing material is wound up in a roll.
